(19) United States
(12) Patent Application Publication
(10) Pub. No.: US 2008/0243492 A1
(43) Pub. Date: Oct. 2, 2008

(54) VOICE-SCRAMBLING-SIGNAL CREATION METHOD AND APPARATUS, AND COMPUTER-READABLE STORAGE MEDIUM THEREFOR

(75) Inventors: Akira Miki, Hamamatsu-shi (JP); Masato Hata, Hamamatsu-shi (JP); Atsuko Ito, Hamamatsu-shi (JP)

Correspondence Address: MORRISON & FOERSTER, LLP, 555 WEST FIFTH STREET, SUITE 3500, LOS ANGELES, CA, 90013-1024, US

(73) Assignee: Yamaha Corporation, Hamamatsu-shi (JP)

(21) Appl. No.: 11/850,605

(22) Filed: Sep. 5, 2007

(30) Foreign Application Priority Data
Sep. 7, 2006 (JP) 2006-242344

(51) Int. Cl. G10L 19/14

(52) U.S. Cl. 704/205

(57) ABSTRACT

Original voice uttered in a first space is acquired via a microphone and a series of digital waveform data of the acquired original voice are obtained. The waveform data are sequentially segmented into plural frames and the waveform data of the individual frames are written into a memory. In parallel with writing, into the memory, of the waveform data, individual ones of the frames already written in the memory are sequentially or randomly selected and read out in a direction opposite to a direction the waveform data of the frame have been written so that a reverse-reproduced voice signal is generated. As the original voice is transmitted, as a leaked voice from the first space to a second space near the first space, a scrambling voice based on the reverse-reproduced voice signal is spatially mixed with the leaked voice in the second space.

### BACKGROUND OF THE INVENTION

The present invention relates to a voice-scrambling-signal creation method and apparatus and a voice scrambling method and apparatus which are suited for use in various applications, such as scrambling of a leaked voice (i.e., conversion of the leaked voice into meaningless or non-understandable voice).

Various voice-scrambling signal creation methods have heretofore been known. One example of such voice-scrambling-signal creation methods is disclosed in Japanese Translation of PCT application (Tokuhyo) No. 2005-534061 which corresponds to WO2004/010627, which is constructed to sequentially divide waveform data of an original voice (speech) into segments on a phoneme-by-phoneme basis, store the waveform data of the individual segments into a memory and create a voice scrambling signal (i.e., signal for scrambling the original voice or leaked voice thereof) by combining the waveform data of a plurality of segments, selected form the memory, in different order from the original voice (speech).

The auditory system of a person, in perceiving voices of another person, creates a voice stream on the basis of physical characteristics clustered after having been subjected to separation and grouping processes etc. (e.g., so-called “cocktail party effect”). According to the above-identified conventionally-known technique, voice scrambling of a first voice stream of, for example, “a”, “i”, . . . is performed by superposing a second voice stream of “i”, “a”, . . . on the above-mentioned first voice stream. In this case, where the order of segments in the second voice stream is merely reversed from that in the first voice stream, the first and second voice streams differ in amplitude envelope and frequency spectrum, so that it is relatively easy to distinguish the first voice from the second voice stream. Thus, the conventionally-known technique would present the problem that the scrambling effect achieved thereby is considerably limited, i.e. considerably low.

### SUMMARY OF THE INVENTION

In view of the foregoing, it is an object of the present invention to provide a novel, improved voice-scrambling-signal creation apparatus and method and voice scrambling method and apparatus which can achieve an enhanced scrambling elect.

In order to accomplish the above-mentioned object, the present invention provides an improved voice-scrambling-signal creation method, which comprises: a step of acquiring an original voice to generate a series of waveform data of the acquired original voice; a writing step of sequentially segmenting the series of waveform data into frames each having a predetermined time length and writing the waveform data of each of the frames into a memory; and a reading step of, in parallel with writing by said writing step of the waveform data, creating reverse-reproduced waveform data by selecting individual ones of the frames from among the frames already written in the memory and reading out, from the memory, the waveform data of the selected frames in such a manner that the waveform data of each of the selected frames are read out in a direction opposite to a direction the waveform data of the frame have been written. The reverse-reproduced waveform data are used as a voice scrambling signal.

According to the voice-scrambling-signal creation method of the present invention, it is preferable that the reading step sequentially selects the individual ones of the frames from among the frames already written in the memory and creates the reverse-reproduced waveform data based on the sequentially selected frames.

According to the voice-scrambling-signal creation method of the present invention arranged in the aforementioned manner, waveform data of an original voice are sequentially segmented into frames, and the waveform data of the individual frames are written into the memory. After completion of writing into the memory of the waveform data of a first one of the frames, the first and subsequent frames are sequentially selected from frames already written in the memory, and reverse-reproduced waveform data are created by reading out, from the memory, the waveform data of the individual selected frames in such a manner that the waveform data of each of the selected frames are read out in a direction opposite to a direction the waveform data of the frame have been written. The reverse-reproduced waveform data are used as a voice scrambling signal. If a scrambling voice is generated on the basis of the thus-created voice scrambling signal (reverse-reproduced waveform data), the original voice and the scrambling voice will become almost identical to each other in overall amplitude envelop and frequency spectrum. Further, if the original voice varies in level, the level of the scrambling voice will vary following the level variation of the original voice. Thus, a high scrambling effect can be achieved by mixing (or superposing the scrambling voice with (or on) the original voice or leaked voice of the original voices.

According to the voice-scrambling-signal creation method of the present invention, it is preferable that a section of the original voice where an autocorrelation coefficient of the original voice is in a range of 0.25 to 0.50 be set as the frame of the predetermined time length. Where the autocorrelation coefficient of the original voice is above 0.5, the correlation between the frames is too high, so that the reverse-reproduced voice would have substantially the same waveform as the original voice and thus a desired voice scrambling can not be attained. Where, on the other hand, the autocorrelation coefficient of the original voice is below 0.25, the correlation between the frames is too low, so that the reverse-reproduced voice and the original voice would become discrete voice streams and thus the original voice may be recognized with considerable ease.

According to the voice-scrambling-signal creation method of the present invention, it is also preferable that the predetermined time length be set within a range of 50 to 200 msec. Because, it is necessary to secure a condition in which the meaning of the original voice can not be understood, taking it account that an average duration of one Japanese phoneme is 100 msec. Namely, if the predetermined time length of the frame is below 50 msec, a section of one phoneme would be segmented into a plurality of frames, in which case the original phoneme can be understood despite the frame-by-frame reverse reproduction. It on the other band, the predetermined time length of the frame is above 200 msec, the time required before all waveform data of a given frame haven been read out would become a time delay relative to the original voice, and thus, a deviation of one phoneme or more would undesirably result. As a consequence, the original voice can be readily heard and recognized separately from the scrambling voice, which would result in a significant reduction in the scrambling effect.

According to the voice-scrambling-signal creation method of the present invention, it is preferable that the reading step randomly selects the individual ones of the frames from among the frames already written in the memory and creates the reverse-reproduced waveform data based on the randomly selected frames.

Preferably, the frames to be randomly selected by the reading step are selected from among a plurality of frames, included in a predetermined time length immediately preceding current write timing (real time), of the frames already written in the memory.

Further, as frames included in a predetermined section of the reverse-reproduced waveform data, a plurality of frames included in a section immediately preceding the predetermined section and having the same length as the predetermined section may be selected, in the reading step, from among the waveform data of the frames already written in the memory, and the selected frames are rearranged in position randomly.

According to still another aspect of the present invention, there is provided a voice-scrambling-signal creation method, which further comprises a step of generating a scrambling voice based on the reverse-reproduced waveform data and emitting the scrambling voice to a space where the original voice is uttered or to a space where the original voice is transmitted as a leaked voice, to thereby spatially mix the scrambling voice with the original voice or the leaked voice.

According to the voice-scrambling-signal creation method, the created reverse-reproduced waveform data are converted into a scrambling voice that are spatially mixed with the original voice or leaked voice of the original voice. Thus, with this voice scrambling method, a high scrambling effect can be attained.

According to another aspect of the present invention, there is provided a voice-scrambling-signal creation apparatus, which comprises: a generation section that acquires an original voice to generate a series of waveform data of the acquired original voice; a writing section that sequentially segments the series of waveform data into frames each having a predetermined time length and writes the waveform data of each of the frames into a memory; and a reading section that, in parallel with writing by said writing section of the waveform data, creates reverse-reproduced waveform data by selecting individual ones of the frames from among the frames already written in the memory and reading out, from the memory, the waveform data of the selected frames in such a manner that the waveform data of each of the selected frames are read out in a direction opposite to a direction the waveform data of the frame have been written. The reverse-reproduced waveform data are used as a voice scrambling signal. This voice-scrambling-signal creation apparatus is constructed to implement the aforementioned voice-scrambling-signal creation method of the present invention and can accomplish the same advantageous results as the aforementioned voice-scrambling-signal creation method.

According to the voice-scrambling-signal creation apparatus of the present invention, it is preferable that the reading section sequentially selects the individual ones of the frames from among the frames already written in the memory and creates the reverse-reproduced waveform data based on the sequentially selected frames.

According to the voice-scrambling-signal creation apparatus of the present invention, it is preferable that the reading section randomly selects the individual ones of the frames from among the frames already written in the memory and creates the reverse-reproduced waveform data based on the randomly selected frames.

According to still another aspect of the present invention, there is provided a voice-scrambling-signal creation apparatus, which further comprises a conversion section that generates a scrambling voice based on the reverse-reproduced waveform data and emits the scrambling voice to a space where the original voice is uttered or to a space the original voice is transmitted to as a leaked voice, to thereby spatially mix the scrambling voice with the original voice or the leaked voice.

According to the voice scrambling apparatus, the created reverse-reproduced waveform data are converted into a scrambling voice that are spatially mixed with the origin voice or leaked voice of the original voice. Thus, with this voice scrambling apparatus, a high scrambling effect can be attained.

Namely, the present invention is characterized in that reverse-reproduced waveform data are created by reading out, from the memory, the waveform data of the individual frames in a direction opposite to the direction the waveform data of the frames have been written and in parallel with writing of the waveform data of the other frames following the first frame and then the reverse-reproduced waveform data are used as a voice scrambling signal. As a result, the present invention can provide a voice scrambling signal of an enhanced scrambling performance. Further, with the arrangement that the thus-created reverse-reproduced waveform data are converted into a scrambling voice that are spatially mixed with the original voice or leaked voice of the original voice, the present invention can achieve a high scrambling effect.

The present invention may be constructed and implemented not only as the method and apparatus invention as discussed above but also as a software program for execution by a processor such as a computer or DSP, as well as a storage medium storing such a software program. Further, the processor used in the present invention may comprise a dedicated processor with dedicated logic built in hardware, not to mention a computer or other general-purpose type processor capable of running a desired software program.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

For better understanding of the objects and other features of the present invention, its preferred embodiments will be described hereinbelow in greater detail with reference to the accompanying drawings, in which:

FIG. 1 is a block diagram showing an electric circuit construction of a voice scrambling apparatus in accordance with an embodiment of the present invention;

FIG. 2 is a flow chart showing waveform data writing/reading processing performed in the embodiment of FIG. 1;

FIG. 3 is a waveform diagram explanatory of the waveform data writing/reading processing performed in the embodiment of FIG. 1;

FIG. 4 is a flow chart showing waveform data writ reading processing performed in a second embodiment of the present invention;

FIG. 5 is a waveform diagram explanatory of the waveform data writing/reading processing performed in the second embodiment; and

FIGS. 6A and 6B are waveform diagram explanatory of the waveform data writing/reading processing performed in the second embodiment.

### DETAILED DESCRIPTION

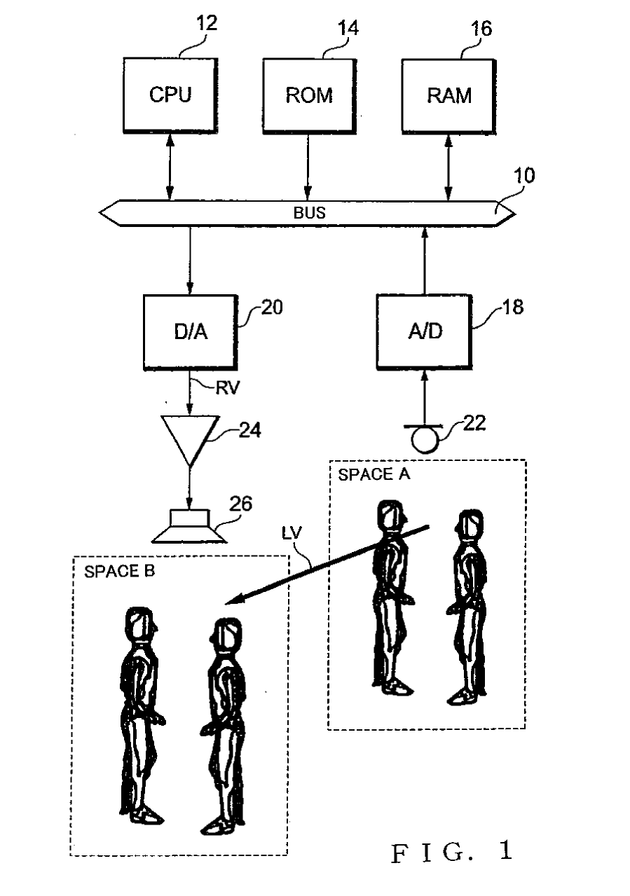

FIG. 1 shows an electric circuit construction of a voice scrambling apparatus in accordance with an embodiment of the present invention, which is provided with a small-size computer.

To a bus 10 are connected a CPU (Central Processing Unit) 12, ROM (Read-Only Memory) 14, RAM (Random Access Memory) 16, ED (Analog-to-Digital) converter 18, D/A (Digital-to-Analog) converter 20, etc.

The CPU 12 writes and reads out waveform to and from the RAM 16 in accordance with a program stored in the ROM 14. Example of such waveform data writing/reading processing will be later described in detail.

Microphone 22 is installed, for example, on a ceiling portion of a space A, and it picks up audible sounds, such as conversational voice and operating sound of an air conditioner, produced in the space A (such voice and sound will hereinafter referred to as “original voice”, for convenience of explanation) and converts the original voice into an electrical original voice signal to supply the original voice signal to the A/D converter 18. The AD converter 18 converts the original voice signal supplied from the microphone 22, into a series of data and sends the thus-converted data to the bus 10.

The D/A converter 20 converts reverse reproduced waveform data, created on the basis of waveform data read out from the RAM 16, into an analog reverse-reproduced voice signal RV. The reverse reproduced waveform signal RV is supplied to a speaker 26 via an amplifier 24 and converted via the speaker 26 into an audible reverse reproduced voice. The reverse reproduced voice is used as a scrambling voice.

As an example, the speaker 26 is installed on a ceiling portion of a space B near the space A. Namely, the speaker 26 is installed in the space B in such a manner that, as an original voice is transmitted, as a leaked voice LV, from the space A to the space B, a scrambling voice generated from the speaker 26 is spatially mixed with the leaked voice LV in the space B. Alternatively, the speaker 26 may be installed in the space A, where the oral voice is acquired (uttered), in such a manner that the scrambling voice is spatially mixed with the original voice in the space B.

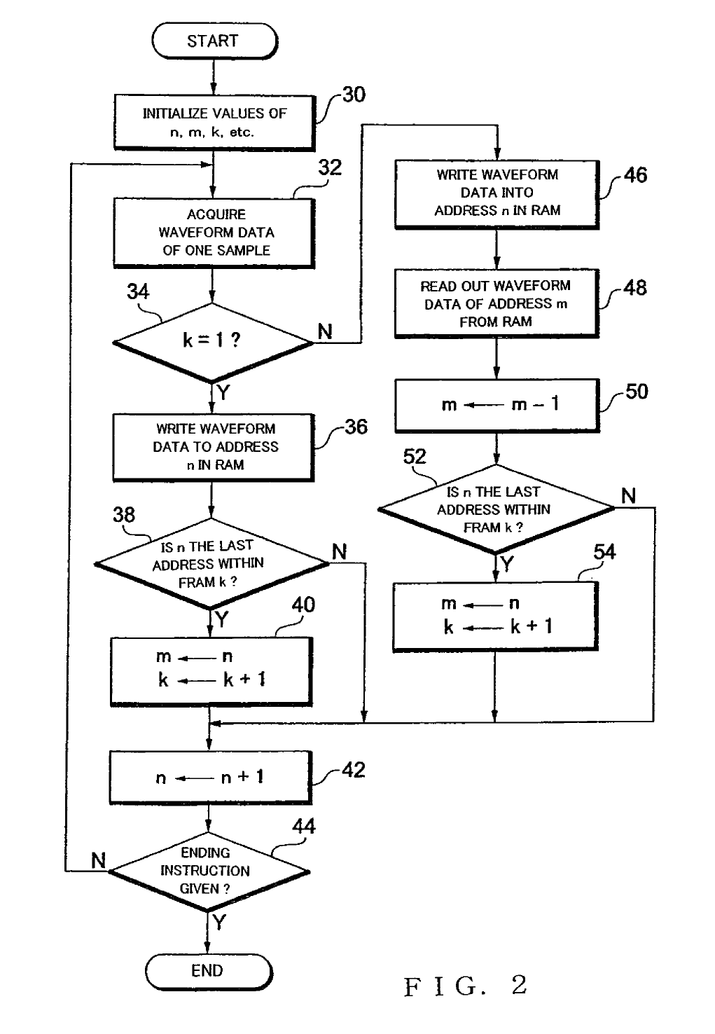

Next, with reference to FIG. 2, a description will be given about processing for writing and reading out waveform to and from the RAM 16. The waveform data writing/reading processing of FIG. 2 is started up, for example, in response to powering-on (i.e., turning-on) of the voice scrambling apparatus. At step 30, an initialization process is performed. For example, write and read addresses n and m are each set at an initial value, and a frame number k is set at a value “1”.

At step 32, waveform data of one sample is acquired, in accordance with sampling order, from the RAM 16 having waveform data, indicative of voice generated in the space A, sequentially written therein. Then, at step 34, a determination is made as to whether the frame number k is “1” (k=1). When the processing has arrived at step 34 with the frame number k set at the initial value as above, the frame number k is “1” and thus a YES (affirmative) determination is made at step 34, so that the processing goes to step 36.

At step 36, the waveform data acquired at step 32 is written into the address n of the RAM 16. At next step 38, a determination is made as to whether the current address n is the last address within the frame F₁₀. Namely, the time length of each frame is preset to within a range of 50-200 msec, and thus, if it is assumed that each frame is preset to a 100 msec time length, whether or not the current address n is the last address within each of the frames F₁, F₂, F₃, . . . can be determined on the basis of a last address value preset or calculated in correspondence to the 100 msec time length. When the processing has arrived at step 38 with the address n set at the initial value (1), a NO (negative) determination is made at step 38, so that the processing goes to step 42.

At step 42, the value of the address n is incremented by one. Then, at step 44, a determination is made as to whether there has been given any ending instruction, such as powering-off (i.e., turning-off) of the voice scrambling apparatus. With a NO determination at step 44, the processing reverts to step 32. At step 32, waveform data of the next sample is acquired. When the processing has arrived at step 36 by way of step 34, the waveform data acquired at this time at step 32 is written into the next address (i.e., address incremented by one at step 42) of the RAM 16. After that, the flow reverts to step 32, by way of steps 38, 42 and 44, to repeat the aforementioned writing process.

Once the address n has reached the last address within the frame F₁, a YES determination is made at step 38, so that the processing goes to step 40. At step 40, the write address n (i.e., last address within the frame F₁) set at a current time point is set as the read address m, and the value of the frame number k is incremented by one so that the frame number k is set at a value “2”. After step 40, the processing reverts to step 32 by way of steps 42 and 44.

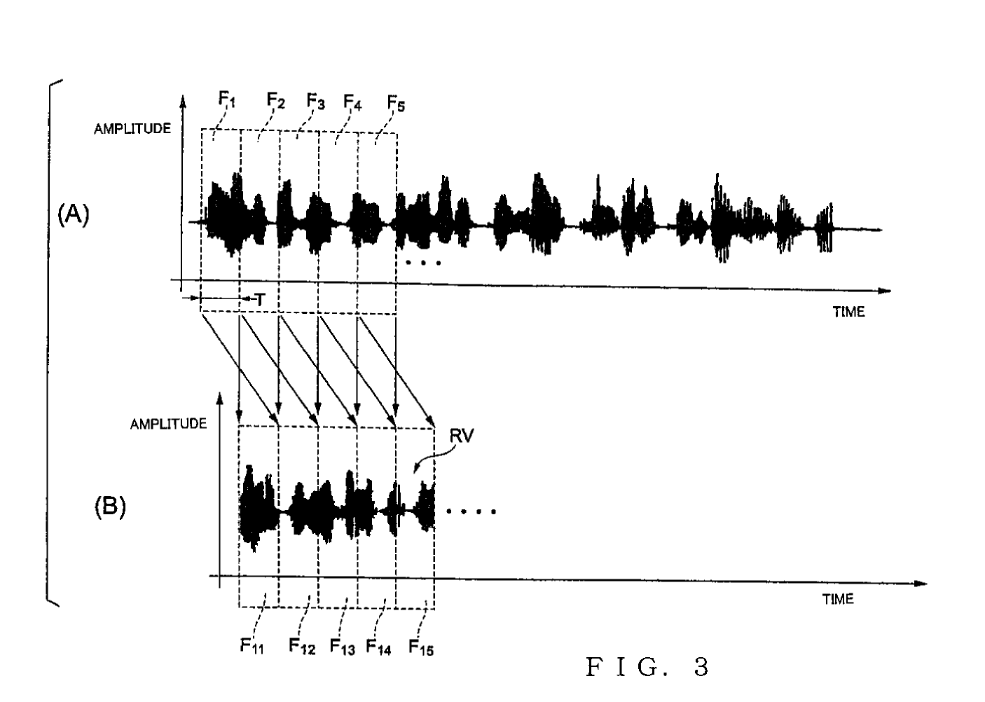

A part (A) of FIG. 3 is explanatory of the aforementioned waveform data writing process, in which waveform data are shown, for convenience of illustration, as an analog waveform (corresponding to an output signal of the microphone 22). F₁, F₂, F₃, . . . indicate a succession of frames, and the time length of each of the frames is preset, for example, at 100 msec, as noted above. Once the frame number K reaches “2”, the address n is incremented by one, and the thus-incremented address indicates the first or leading address within the frame F₂. After that, waveform data of the first sample within the frame F₂ is acquired at step 32.

Then, once the processing arrives at step 34 with the frame number K set at “2”, a NO determination is made, so that the processing branches to step 46. At step 46, the waveform data acquired at step 32 is written into the address n of the RAM 16 (i.e., first write address of the frame F₂).

Then, at step 48, waveform data of the address m is read out from the RAM 16. Namely, because the address m has been set, at step 40, to the last address within the frame F₁, waveform data of the last address is read out from the RAM 16 and supplied to the D/A converter 20, at this step. Then, at step 50, the value of the address m is decremented by one; this is for the purpose of reading out waveform data in a direction opposite to (i.e., reverse to) the direction in which the waveform data have been written.

At step 52, a determination is made as to whether the address n is the last address within the frame Fₖ. When waveform data has been written into the first address within the frame F₂, a NO determination is made at step 52, so that the processing moves to step 42.

At step 42, the value of the address n is incremented by one. Then, the processing reverts to step 32 by way of step 44. At step 32, waveform data of the next sample is acquired. Then, when the processing has arrived at step 46 by way of step 34, the waveform data acquired at step 32 is written into the address n (i.e., address incremented by one at step 42) of the RAM 16. Then, at step 48, waveform data of the address m (i.e., address decremented by one at step 50) is read out from the RAM 16 and supplied to the D/A converter 20. After that, the processing reverts to step 32, by way of steps 50, 52, 42 and 44, so that waveform data reading is performed in parallel with the waveform data writing in a manner similar to the aforementioned.

A part (B) of FIG. 3 is explanatory of the waveform data reading performed in parallel with the waveform data writing. F₁₁, F₁₂, F₁₃, . . . indicate read frames which correspond to the written frames F₁, F₂, F₃, . . . . Upon completion of writing of the waveform data of the first frame F₁, the waveform data of the first frame F₁ are read out, in a direction opposite to the direction in which the waveform data of the frame have been written, from the RAM 16 in parallel with writing of the waveform data of the second frame F₂ into the RAM 16. In this manner, waveform data created by reverse-reproducing the waveform data of the first frame F₁ are provided as waveform data of the frame F₁₁.

Once the address n reaches the last address within the frame F₂, a YES determination is made at step 52, so that the processing goes to step 54. At step 54, the write address n (i.e., last address within the frame F₂) set at the current time point is set as the read address m, and the value of the frame number k is incremented by one. As a consequence, the frame number k is set to “3”, if the last frame number k was “2”. After step 54, the processing reverts to step 32 by way of steps 42 and 44.

After that, the waveform data of the second frame F₂ are read out, in a direction opposite to the direction in which the waveform data of the second frame F₂ have been written, from the RAM 16 in parallel with writing of the waveform data of the third frame F₃ into the RAM 16; in this manner, reverse-reproduced waveform data of the frame F₁₂ are obtained by reverse reproduction of the waveform data of the second frame F₂. Similarly, reverse-reproduced waveform data of the frame F₁₃ are obtained by reverse reproduction of the waveform data of the third frame F₃ in parallel with writing of the waveform data of the fourth frame F₄, reverse-reproduced waveform data of the frame F₁₄ are obtained by reverse reproduction of the waveform data of the fourth frame F₄ in parallel with writing of the waveform data of the fifth frame F₅, and so on.

If there has been given an ending instruction, such as powering-off of the voice scrambling apparatus, a YES determination is made at step 44, so that the processing is brought to an end.

The time length of each frame has been described above as preset to a fixed value within the range of 50-200 msec. Alternatively, a time point at which an autocorrelation coefficient of the original voice is in a range of 0.25 to 0.50 may be set as a frame breakpoint so that the waveform data can be segmented using such frame breakpoints. In such a case, the frame segmentation does not depend on the predetermined time length (50-200 msec). Thus, in a case where the original voice has a high speech rate (representing a rapid speech), this alternative arrangement can effectively prevent the inconvenience that a masking effect can not be attained because the predetermined time length is too long; conversely, in a case where a long vowel is contained in current voice, the alternative arrangement can prevent the inconvenience that a masking effect can not be attained because the predetermined time length is too short. Since the length varies among the frames in this case, the respective lengths of the frames are stored so that the last address determination is made, at steps 38 and 52, in accordance with the stored length.

The reverse-reproduced waveform data of the F₁₁, F₁₂, F₁₃, . . . are sequentially supplied to the D/A converter 20, by which the supplied waveform data are converted into an analog reverse-reproduced voice signal RV as illustratively shown in FIG. 3(B). The reverse-reproduced voice signal RV is supplied via the amplifier 24 to the speaker 26, where it is converted into an audible reverse-reproduced voice. The reverse-reproduced voice is spatially mixed, as a scrambling voice, with a leaked voice LV in the space B. The reverse-reproduced voice (“masker”), which is generated on the basis of sound originally generated in the space A, is similar in various acoustic characteristics, such as spectral characteristics, to the leaked voice LV (“maskee”). Thus, a high scrambling effect can be attained even where the volume level of the scrambling voice at the time of the spatial is considerably low like that of the leaked voice LV.

In a case where a conversation takes place in the space A and a leaked voice LV is transmitted from the space A to the space B, for example, a person in the space B hears a mixed voice consisting of the leaked voice LV and scrambling voice. Thus, in this case, it is possible to prevent the possibility that the person in the space B can not understand the meaning of the conversation due to the scrambling effect and gets distracted by the contents of the original voice. Further, where a person wants a highly secret conversation, security of the conversation can be secured if the person has the conversation in the space A. Note that, because the scrambling voice too is audibly reproduced in the space B after being converted into a meaningless voice, there is no possibility of the contents of the conversation in the space A being caught by way of the scrambling voice itself.

Whereas the embodiment has been described above as being provided with the AD and D/A converters 18 and 20, the A/D and D/A conversion processes may be performed by a computer.

The embodiment of the present invention has been described above in relation to the case where waveform data written in the RAM 16 are sequentially read out from the RAM 16 in the order the waveform data of the individual frames have been written and then reproduced-waveform data are generated on the basis of the read-out waveform data. Alternatively, however, reverse-reproduced waveform data may be generated by reading out frames from the RAM 16 in random order, as will be described below as a second embodiment of the invention. The second embodiment too assumes that the time length of each of the frames is preset at 100 msec.

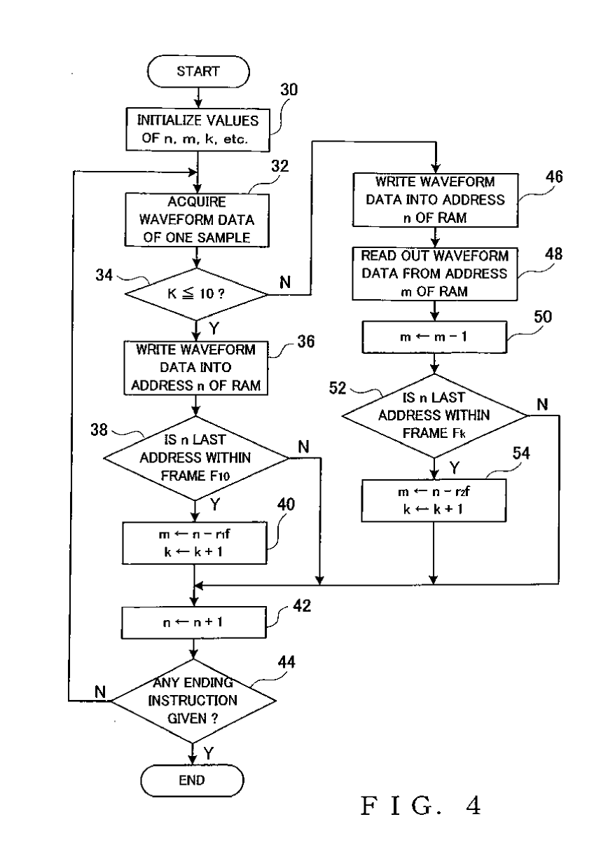

Waveform data writing/reading processing performed in the second embodiment will be descried below with reference to a flow chart of FIG. 4. At step 30, an initialization process is performed, where write and read addresses n and m are each set at an initial value, and a frame number k is set at a value “1”.

At step 32, waveform data of one sample is acquired, in accordance with sampling order, from the RAM 16 having waveform data, indicative of a voice generated in the space A, sequentially written therein. Then, at step 34, a determination is made as to whether the frame number k is of a value equal to or smaller than “10”. When the processing has arrived at step 34 with the frame number k set at the initial value as above, the frame number k is “1”, and thus a YES affirmative) determination is made at step 34, so that the processing goes to step 36.

At step 36, the acquired waveform data is written into the address n of the RAM 16. At next step 38, a determination is made as to whether the current address n is the last address within the frame F₁₀. When the processing has arrived at step 38 with the address n set at the initial value, a NO (negative) determination is made at step 38, so that the processing goes to step 42. Note that the last address within the frame F₁₀ can be calculated on the basis of the number of addresses of each frame.

At step 42, the value of the address n is incremented by one. Then, at step 44, a determination is made as to whether there has been given any ending instruction, such as powering-off (turning-off) of the voice scrambling apparatus. With a NO determination at step 44, the processing reverts to step 32. At step 32, waveform data of the next sample is acquired. When the processing has arrived at step 36 by way of step 34, the waveform data acquired at step 32 is written into the next address (i.e., address incremented by one at step 42) of the RAM 16. After that, the flow reverts to step 32, by way of steps 38, 42 and 44, to repeat the aforementioned writing process.

Once the frame number k reaches the value “10” through repetition of the aforementioned operations, the following operations take place. Once the current address n reaches the last address within the frame F₁₀, a YES determination is made at step 38, and the processing moves on to step 40. At step 40, “n−r₁f” is set as the read address m. Here, “r₁” represents an integer in the range of 0 to 9; at each predetermined timing, the integer r₁ is selected randomly from the range of 0 to 9. Further, “f” represents the total number of addresses included in each frame (i.e., a value obtained by dividing the time length of the frame by the cyclic sampling period). As a consequence, the read address m is set at the last address of any one of frame F₁ to frame F₁₀, and the value of the frame number k is incremented by one so that the frame number k is now set at a value “11”. After step 40, the processing reverts to step 32 by way of steps 42 and 44.

At step 32, waveform data of the first sample in the frame F₁₁ is acquired. When the processing has arrived at step 34 with the frame number k set at “11” (k=11), a NO (negative) determination is made at step 34, so that the processing branches to step 46. At step 46, the waveform data acquired at step 32 is written into the address n of the RAM 16 (i.e., first write address within the frame F₁₁). Then, at step 48, waveform data of the address m is read out from the RAM 16. Namely, because the address m has been set, at step 40, to the last address within any one of frames F₁ to F₁₀, waveform data of the last address is read out from the RAM 16 and supplied to the D/A converter 20. Then, at step 50, the value of the address m is decremented by one.

At step 52, a determination is made as to whether the address n is the last address within the frame Fₖ. When waveform data has been written into the first address within the frame F₁₁ at step 46, a NO determination is made at step 52, so that the processing moves to step 42. At step 42, the value of the address n is incremented by one. Then, the processing reverts to step 32 by way of step 44. At step 32, waveform data of the next sample is acquired. Then, when the processing has arrived at step 46 by way of step 34, the waveform data acquired at step 32 is written into the address n (i.e., address incremented by one at step 42) of the RAM 16. Then, at step 48, waveform data of the address m (i.e., address decremented by one at step 50) is read out from the RAM 16 and supplied to the D/A converter 20. After that, the process reverts to step 32, by way of steps 50, 52, 42 and 44, so that waveform data reading is performed in parallel with the waveform data writing in a manner similar to the aforementioned.

Once the current address n reaches the last address within the frame F₁₁, a YES determination is made at step 52, and the processing moves on to step 54. At step 54, “n−r₂f” is set as the read address m. Here, “r₂” represents an integer randomly selected from the range of 0 to 9 similarly to “r₁”, and the value of the frame number k is also incremented by one at step 54 so that, if the frame number k has so far been set at “11”, it is set at a value “12”. After step 54, the processing reverts to step 32 by way of steps 42 and 44.

After that, waveform data is read out from the newly-set read address m in a direction opposite to (reverse to) the direction in which the waveform data have been written, and new waveform data is accumulated at the address n of the RAM 16.

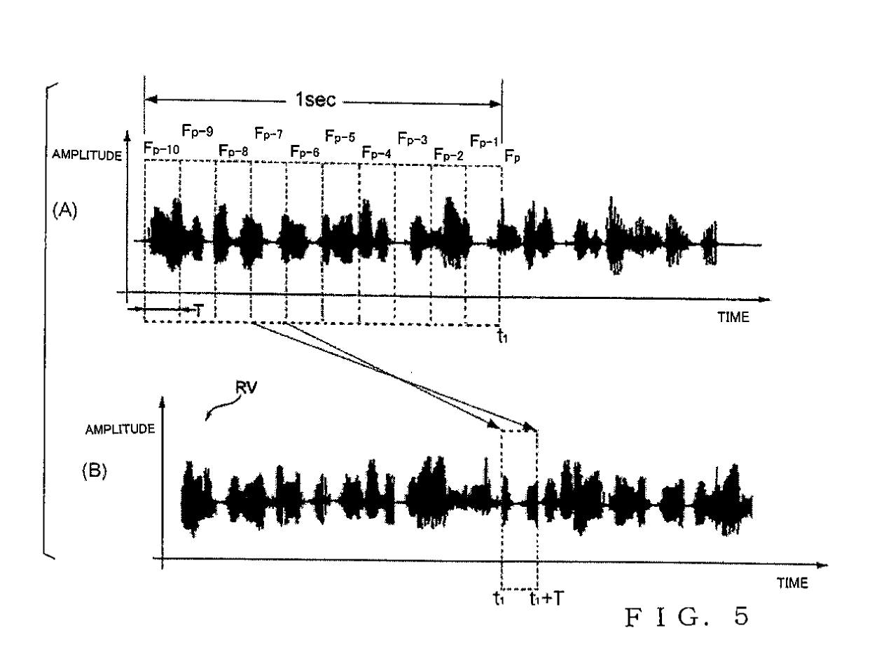

FIG. 5 shows waveform data written into the RAM 16 and a reverse-reproduced voice signal RV generated on the basis of the waveform data through the above-described processing. In a part (A) of FIG. 5, there are shown data at a stage when a sufficient time has passed from the start of the processing. According to the above-described processing, writ of the waveform data of a frame Fₚ₋₁ is completed at time point t₁, followed by writing of the waveform data of a frame Fₚ. In parallel with the writing of the waveform data of the frame Fₚ, one of frames Fₚ₋₁₀ to Fₚ₋₁ (corresponding to a one-sec period) is selected and the waveform data of the selected frame are read out in the opposite direction (to the direction the waveform data have been written) from time point t₁ onward. In a part (B) of FIG. 5, there is shown an example where the waveform data of the frame Fₚ₋₇ are read out. Namely, in generation of individual frames of the reverse-reproduced voice signal RV, the frames are generated from the waveform data written in a one-sec period immediately before current write timing (real time). At that time, frames are selected randomly from the waveform data in the one-sec period immediately before the current write timing.

In the above-described process, the time length of each frame may be other than 100 msec. Further, r₁ and r₂ may be selected from any other suitable integer range than “0” to “9”, such as “0” to “19”, in which case a reverse-reproduced voice signal RV at each predetermined tiring is generated on the basis of waveform data in a two-sec period preceding the current write timing (real time). Whereas waveform data, on the basis of which a reverse-reproduced voice signal RV is generated, are not limited to the aforementioned range, it is preferable to not read out and use waveform data written in a time period past a predetermined time, in order to prevent great differences in amplitude envelope and frequency spectrum between the waveform data written in real time in the RAM 16 and a reverse-reproduced voice signal RV being generated at that time point.

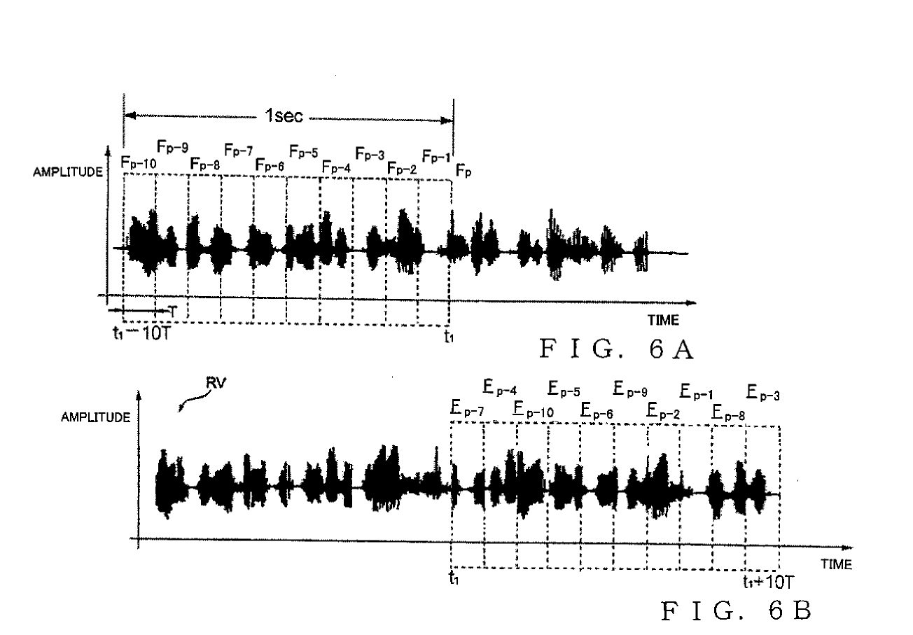

Further, whereas the processing has been described above in relation to the case where each frame of a reverse-reproduced voice signal RV is selected randomly from an immediately-preceding one-sec period, the frames may be positionally rearranged as explained below with reference to FIGS. 6A and 6B.

The RAM 16 has waveform data sequentially written therein. In this case too, a reverse-reproduced voice signal RV is generated by positionally rearranging the waveform data frame by frame. At that time, a reverse-reproduced voice signal RV is generated with a predetermined number of frames (e.g., ten frames that correspond to waveform data of a one-sec time period) as a basic unit. For example, as shown in FIGS. 6A and 6B, a reverse-reproduced voice signal RV of a section “t₁ to t₁+10T” is generated by reading out, from the RAM 16, the waveform data of a predetermined number of frames (in this case, ten frames) immediately preceding that section (see FIG. 6A). At that time, the read-out frames are positionally rearranged randomly, and the waveform data of these frames are reverse-reproduced. In FIG. 6B, each underlined “F” Namely “F”) represents reverse-reproduced waveform data of the corresponding frame F. Then, upon arrival at a time “t₁+10T”, a frame of the next section (“t₁+10T to t₁+20T”) is generated from the waveform data of a section from t₁ to t₁+10T in a similar manner to the aforementioned. Reverse-reproduced voice signals RV may be sequentially generated, with the predetermined number of frames as a basic unit, in the aforementioned manner.

So far, the inventive method for generating a reverse-reproduced voice signal RV has been described in relation to two primary examples. In short, for generation of a reverse-reproduced voice signal RV according to the inventive method, it is only necessary that waveform data frames, each having a predetermined time length, already written in the RAM 16 be read out in random order and the waveform data of each of the frames be read out in a direction reverse to the direction the waveform data have been written.

This application is based on, and claims priority to, Japanese Patent Application No. 2006-242344 filed on Sep. 7, 2006. The disclosure of the priority application, in its entirety, including the drawings, claims, and the specification thereof is incorporated herein by reference.

What is claimed is:

1. A voice-scrambling-signal creation method comprising:
a step of acquiring an or voice to generate a series of waveform data of the acquired original voice;
a wring step of sequentially segmenting the series of waveform data into frames each having a predetermined time length and writing the waveform data of each of the frames into a memory; and
a reading step of, in parallel with wring by said writing step of the waveform data, creating reverse-reproduced waveform data by selecting individual ones of the frames from among the frames already written in the memory and reading out, from the memory, the waveform data of the selected frames in such a manner that the waveform data of each of the selected frames are read out in a direction opposite to a direction the waveform data of the frame have been written,
wherein the reverse-reproduced waveform data are used as a voice scrambling signal.

2. A voice-scrambling-signal creation method as claimed in claim 1, wherein said reading step sequentially selects the individual ones of the frames from among the frames already written in the memory and creates the reverse-reproduced waveform data based on the sequentially selected frames.

3. A voice-scrambling-signal creation method as claimed in claim 1 wherein a section of the original voice where an autocorrelation coefficient is in a range of 0.25 to 0.50 is set as the frame having the predetermined time length.

4. A voice-scrambling-signal creation method as claimed in claim 1 wherein the predetermined time length is set within a range of 50 to 200 msec.

5. A voice-scrambling-signal creation method as claimed in claim 1, wherein said reading step randomly selects the individual ones of the frames from among the frames already written in the memory and creates the reverse-reproduced waveform data based on the randomly selected frames.

6. A voice-scrambling-signal creation method as claimed in claim 5 wherein the frames to be randomly selected by said reading step are selected from among a plurality of frames, included in a predetermined time length immediately preceding current write timing, of the frames already written in the memory.

7. A voice-scrambling-signal creation method as clamed in claim 5 wherein, as frames included in a predetermined section of the reverse-reproduced waveform data, a plurality of frames included in a section immediately preceding the predetermined section and having a same length as the predetermined section are selected from among the waveform data of the frames already written in the memory, and the selected frames are positionally rearranged randomly.

8. A voice-scrambling-signal creation method as claimed in claim 1, which further comprises a step of generating a scrambling voice based on the reverse-reproduced waveform data and emitting the scrambling voice to a space where the original voice is uttered or to a space where the original voice is transmitted as a leaked voice, to thereby spatially mix the scrambling voice with the original voice or the leaked voice.

9. A voice-scrambling-signal creation apparatus comprising:
a generation section that acquires an original voice to generate a series of waveform data of the acquired original voice;
a writing section that sequentially segments the series of waveform data into frames each having a predetermined time length and writes the waveform data of each of the frames into a memory; and
a reading section that, in parallel with writing by said writing section of the waveform data, creates reverse-reproduced waveform data by selecting individual ones of the frames from among the frames already written in the memory and reading out, from the memory, the waveform data of the selected frames in such a manner that the waveform data of each of the selected frames are read out in a direction opposite to a direction the waveform data of the frame have been written,
wherein the reverse-reproduced waveform data are used as a voice scrambling.

10. A voice-scrambling-signal creation apparatus as claimed in claim 9, wherein said reading section sequentially selects the individual ones of the frames from among the frames already written in the memory and creates the reverse-reproduced waveform data based on the sequentially selected frames.

11. A voice-scrambling-signal creation apparatus as claimed in claim 9, wherein said reading section randomly selects the individual ones of the frames from among the frames already written in the memory and creates the reverse-reproduced waveform data based on the randomly selected frames.

12. A voice-scrambling-signal creation apparatus as claimed in claim 9, which further comprises a conversion section that generates a scrambling voice based on the reverse-reproduced waveform data and emits the scrambling voice to a space the original voice is uttered from or to a space the original voice is transmitted to as a leaked voice, to thereby spatially mix the scrambling voice with the original voice or the leaked voice.

13. A computer-readable storage medium containing a group of instructions for causing a computer to perform a voice-scrambling-signal creation procedure, said voice-scrambling-signal creation procedure comprising:
a step of acquiring an original voice to generate a series of waveform data of the acquired original voice;
a writing step of sequentially segmenting the series of waveform data into frames each having a predetermined time length and writing the waveform data of each of the frames into a memory; and
a reading step of, in parallel with writ said writing step of the waveform data, creating reverse-reproduced waveform data by selecting individual ones of the frames from among the frames already written in the memory and reading out, from the memory, the waveform data of the selected frames in such a manner that the waveform data of each of the selected frames are read out in a direction opposite to a direction the waveform data of the frame have been written,
wherein the reverse-reproduced waveform data are used as a voice scrambling signal.

14. A computer-readable storage medium as claimed in claim 13, wherein said reading step sequentially selects the individual ones of the frames from among the frames already written in the memory and creates the reverse-reproduced waveform data based on the sequentially selected frames.

15. A computer-readable storage medium as claimed in claim 13, wherein said reading step randomly selects the individual ones of the frames from among the frames already written in the memory and creates the reverse-reproduced waveform data based on the randomly selected frames.

16. A computer-readable storage medium as claimed in claim 13, wherein said voice scrambling procedure further comprises a step of generating a scrambling voice based on the reverse-reproduced waveform data and emitting the scrambling voice to a space the original voice is uttered from or to a space the original voice is transmitted to as a leaked voice, to thereby spatially mix the scrambling voice with the original voice or the leaked voice.
